(19) United States
(12) Patent Application Publication
(10) Pub. No.: US 2006/0214315 A1
(43) Pub. Date: Sep. 28, 2006

(54) HUMIDIFIER DEVICE AND METHOD OF OPERATION

(75) Inventor: Matthew A WILLIAMS, St. Louis, MO (US)

Correspondence Address: LOCKE LIDDELL & SAPP LLP;ATTN. DOCKETING, 600 TRAVIS #3400, HOUSTON, TX, 77002, US

(73) Assignee: EMERSON ELECTRIC CO, ST. LOUIS, MO (US)

(21) Appl. No.: 11/277,522

(22) Filed: Mar. 27, 2006

Related U.S. Application Data
(60) Provisional application No. 60/594,290, filed on Mar. 25, 2005.

(51) Int. Cl. B01F 3/04

(52) U.S. Cl. 261/26; 261/104; 261/129

(57) ABSTRACT

A humidifier includes a water tray with a filter situated to wick water from the water tray. A fan is operable to move ambient air into the humidifier through an inlet, through the filter to humidify the air, and out of the humidifier through an outlet. A control housing contains a humidistat and a controller. The control housing is situated in the humidified air stream and defines an ambient air inlet. The controller is programmed to vary the speed of the fan in response to the difference between the humidity level of the ambient air sensed by the humidistat and a desired humidity. The controller further operates the fan for a predetermined time period after the water tray is emptied.

### CROSS-REFERENCE TO RELATED APPLICATION

This application is a non-provisional application of U.S. Provisional Patent Application No. 60/594,290, filed on Mar. 25, 2005, and which is incorporated by reference.

### BACKGROUND

The present invention relates generally to humidifiers and the operation thereof.

Humidifiers are well known and commonly used in households and businesses to add moisture to indoor air providing a more comfortable living environment. A comfortable level of relative humidity is generally 30-50% in the winter and 40-50% in the summer. If the humidity level is lower, atopic dermatitis, excessive static electricity, drying out of furniture and other various concerns may occur. A humidifier's many advantages include alleviating a cold sufferer's sore throat, reducing any difficulty in breathing, and generally improving the health and comfort of the user's home.

Several varieties of humidifiers exist, differing in both humidification methods, size and refilling. The method of humidification varies from evaporative, ultrasonic, cool mist impeller, steam vaporizers and warm mist humidifiers. An evaporative humidifier is often called a “wicking” humidifier because is employs a large “wick” or filter. The wick or filter draws water upward from a water reservoir base through capillary action. A fan blows air across or through the filter thereby diffusing moisture throughout the room.

The varying sizes include table top, console and central humidifiers. While tabletop designs typically humidify one room, console and central humidifiers may humidify multiple rooms or an entire house. Table top and console humidifiers require manual filling of the water while central humidifiers connect directly to the water pipeline of the house.

Some humidifiers employ an automatic control scheme, wherein the humidity level of the room is monitored and the fan is operated in response to the humidity level—if the relative humidity rises above some predetermined level, the fan is turned off, and fan is automatically turned back on when the humidity level drops below the predetermined level. However, such systems operate in a binary mode: the fan is either on or off. This can result in humidity over-shoot. Bacteria growth on the humidifier filter and the humidifier itself is also problematic. When the humidifier water reservoir empties, the fan is typically turned off to conserve power. Unfortunately, this can result in the filter remaining wet for an extended period of time, providing a moist environment for bacteria to grow.

Moreover, sensing the humidity of the surrounding environment can be problematic. For instance, if the humidifier controls are situated in the path of the humidified exhaust airflow, the control is completely surrounded by humidified air under positive pressure. This prevents the humidistat from receiving fresh ambient air, in turn preventing the room conditions from being controlled by the humidifier. One attempted solution is to use ductwork to carry negative pressure air created by the pull of air by the exhaust fan to the control. However, such ductwork adds material and labor costs to the product.

The teachings of the present disclosure address associated shortcomings in the prior art.

### SUMMARY

In accordance with certain teachings of the present disclosure, a humidifier includes a water tray with a filter situated to wick water from the water tray. A fan is operable to move ambient air into the humidifier through an inlet, through the filter to humidify the air, and out of the humidifier through an outlet. A is controller programmed to operate the fan such that the fan continues to operate after the water tray is emptied to dry out the filter. For example, the controller can be programmed to operate the fan for a predetermined time period after the water try is emptied. In other embodiments, after the water try is emptied, the controller can turn off the fan when the filter is dry. This can be determined by sensing the difference between the inlet and outlet temperatures.

In some exemplary embodiments, the humidifier includes humidistat connected to the controller and the controller is programmed to vary the speed of the fan in response to the difference between the humidity level sensed by the humidistat and a desired humidity. In still further embodiments, a control housing contains the humidistat and the controller, and the control housing defines an ambient air inlet and a pressure tap. The control housing is situated in the humidified air stream so as to create a restriction in airflow and reduce pressure in the area of the pressure tap, resulting in ambient air entering the ambient air inlet.

### BRIEF DESCRIPTION OF THE DRAWINGS

Other objects and advantages of the invention will become apparent upon reading the following detailed description and upon reference to the drawings in which:

FIG. 1 is a block diagram showing a side view of an exemplary humidifier, conceptually illustrating various teachings of the present disclosure.

FIG. 2 is a block diagram showing a top view of the exemplary humidifier shown in FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

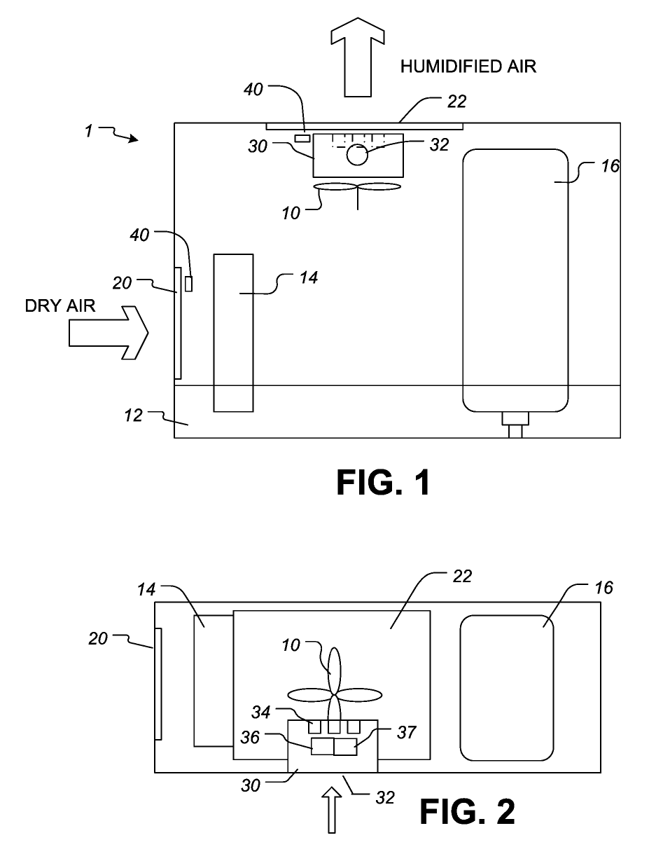

Turning to the figures, and in particular FIG. 1, an exemplary humidifier 1 in accordance with certain teachings of the present disclosure is conceptually illustrated. The humidifier 1 includes a fan 10, a water tray 12 and a wick, or filter 14 partially disposed within the water tray 12. Water is discharged from a water bottle 16 into the water tray 12. The water bottle 16 may be removed from the humidifier periodically or as needed for refilling, cleaning or other purposes. The filter 14 absorbs water from the water tray 12 and, in turn, supplies moisture to an air stream entering the humidifier 1 via an air intake 20, which is propelled through the humidifier 1 by the fan 10. The humidified air exits the humidifier 1 through an air exhaust 22.

A humidifier controller housing 30 includes manual controls such as “on” and “off” actuators and a humidity level selector (not shown). A programmable controller 36 including a humidistat 37 is also situated in the controller housing 30. Additionally, an ambient air intake 32 is defined in the controller housing 30. The controller housing 30 is positioned in the exhaust airflow of the fan 10, which creates a restriction of the airflow. The restriction increases the velocity of the fluid flow, resulting in a reduction in pressure less than the ambient pressure in the area of pressure tap openings 34. The pressure taps 34 are situated at the end of the airflow restriction in a region of lower than ambient air pressure, which generates airflow through the controller module 30 due to the reduction in pressure caused by the flow restriction. Air from the room enters the ambient air intake 32, flows through the controller module 30 where it is sensed by the humidistat 37, and into the humidified air stream through the pressure taps 34.

In certain embodiments, a user can set the speed of the fan 10 at various speeds as desired. An “AUTO” speed setting is also provided, in which the controller 36 is programmed to operate the fan in response to the humidity level as determined by the humidistat 37. In the AUTO setting, the controller is programmed to vary the speed of the fan 10, rather than simply turn it on when the humidity is below a desired level and turn off the fan when it reaches the desired level. Rather, the fan speed is varied until the desired humidity level is achieved.

For example, the humidity set point could be set to 45% relative humidity (RH). if the sensed humidity is 10% RH or more below the set point, the fan 10 is operated at a first speed. If the room humidity is 5-10% RH below the set point, the fan 10 is operated at a slower speed, and the fan 10 is operated at a still slower speed if the room humidity is within 5% RH of the set point. Reducing the fan speed as the humidity approaches the humidity set point reduces the rate of water output from the humidifier. This reduces the amount of humidity overshoot by providing increased time for the mixing of the dry and moist air, and also reduces fluctuations of the humidistat 37 sensor readings. If, after some predetermined time period, the room humidity has not increased by a minimum amount, the fan speed is increased.

In some embodiments, an automatic filter dry out feature is provided. To reduce bacteria growth on the filter 14 and the humidifier itself, the fan 10 continues to operate after the water tray 12 is empty. More specifically, when the water tray 12 becomes empty, the controller 36 runs the fan 10 on it's slowest speed setting for a predetermined time period. During this dry out operation, if the sensed room humidity reaches or exceeds the set point humidity, the controller 36 turns the fan 10 off until the humidity falls below the set point level.

Moreover, in further embodiments, the controller turns the fan 10 off prior to the expiration of the predetermined time period if it is determined that the filter 14 is dry. One method of determining whether the filter 14 has dried out includes checking for evaporative cooling. This is done by comparing the inlet and outlet air temperatures. If the temperature difference between the inlet and outlet is greater than some predetermined amount, evaporative cooling is occurring indicating that the filter 14 is wet. If the temperature difference is less than the predetermined difference, the filter is ineffective, dry, and the fan 10 is shut off.

In the illustrated exemplary embodiment, thermistors 40 are situated near the inlet 20 and the outlet 22. The controller 36 receives outputs from the thermisters 40 and senses the resistance of the thermistors 30 to determine the temperature difference between the inlet 20 and the outlet 22.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A humidifier, comprising
a water tray;
a filter situated to wick water from the water tray;
a fan operable to move ambient air into the humidifier through an inlet, through the filter to humidify the air, and out of the humidifier through an outlet; and
a controller programmed to operate the fan such that the fan continues to operate after the water tray is emptied to dry out the filter.

2. The humidifier of claim 1, wherein the controller is programmed to operate the fan for a predetermined time period after the water try is emptied.

3. The humidifier of claim 1, further comprising a humidistat connected to the controller, wherein after the water tray is emptied, the controller turns off the fan if humidity level of the ambient air sensed by the humidistat is higher than a predetermined level.

4. The humidifier of claim 1, wherein after the water try is emptied, the controller turns off the fan if the filter is dry.

5. The humidifier of claim 4, further comprising inlet and outlet air temperature sensors connected to the controller, the controller turning off the fan in response to the difference between the sensed inlet and outlet temperatures being less than a predetermined amount.

6. The humidifier of claim 5, wherein the inlet and outlet temperature sensors are thermistors.

7. The humidifier of claim 1, further comprising a humidistat connected to the controller, wherein the controller is programmed to vary the speed of the fan in response to the difference between the humidity level sensed by the humidistat and a desired humidity.

8. The humidifier of claim 1, further comprising:
a humidistat connected to the a controller; and
a control housing containing the humidistat and the controller, the control housing defining an ambient air inlet and a pressure tap, the control housing being situated in the humidified air stream so as to create a restriction in airflow and reduce pressure in the area of the pressure tap, resulting in ambient air entering the ambient air inlet.

9. A humidifier, comprising:
a water tray;
a filter situated to wick water from the water tray;
a fan operable to move ambient air into the humidifier through an inlet, through the filter to humidify the air, and out of the humidifier through an outlet; and
a control housing containing a humidistat and a controller, the control housing defining an ambient air inlet and a pressure tap, the control housing being situated in the humidified air stream so as to create a restriction in airflow and reduce pressure in the area of the pressure tap, resulting in ambient air entering the ambient air inlet.

10. The humidifier of claim 9, wherein the controller is programmed to vary the speed of the fan in response to the difference between the humidity level of the ambient air sensed by the humidistat and a desired humidity.

11. The humidifier of claim 9, wherein the controller is programmed to operate the fan for a predetermined time period after the water try is emptied.

12. The humidifier of claim 11, wherein after the water tray is emptied, the controller turns off the fan if humidity level of the ambient air sensed by the humidistat is higher than a predetermined level.

13. The humidifier of claim 9, wherein after the water try is emptied, the controller turns off the fan if the filter is dry.

14. The humidifier of claim 13, further comprising inlet and outlet air temperature sensors connected to the controller, the controller turning off the fan in response to the difference between the sensed inlet and outlet temperatures being less than a predetermined amount.

15. The humidifier of claim 14, wherein the inlet and outlet temperature sensors are thermistors.

16. A method of humidifying air, comprising:
situating a filter to wick water from a water tray;
operating a fan to move ambient air through the filter to humidify the air; and
continuing to operate the fan after the water tray is emptied to dry out the filter.

17. The method of claim 16, wherein continuing to operate the fan after the water tray is emptied includes operating the fan for a predetermined time period after the water try is emptied.

18. The method of claim 16, further comprising, after the water tray is emptied, turning off the fan if the humidity level of the ambient air is higher than a predetermined level.

19. The method of claim 16, further comprising, after the water try is emptied:
determining whether the filter is dry; and
turning off the fan if the filter is dry.

20. The method of claim 19, wherein turning off the fan if the filter is dry includes determining the temperature of air entering and exiting the filter, and turning off the fan in response to the temperature differential between the air entering and exiting the filter.

21. The method of claim 16, further comprising varying the speed of the fan in response to the difference between the humidity level of the ambient air and a desired humidity.
